(19) United States
(12) Patent Application Publication
(10) Pub. No.: US 2011/0012798 A1
(43) Pub. Date: Jan. 20, 2011

(54) SYSTEM AND METHOD FOR IMPROVING MIMO PERFORMANCE OF VEHICULAR BASED WIRELESS COMMUNICATIONS

(75) Inventor: Anthony Triolo, Manalapan, NJ (US)

Correspondence Address: TELCORDIA TECHNOLOGIES, INC., ONE TELCORDIA DRIVE 5G116, PISCATAWAY, NJ, 08854-4157, US

(73) Assignee: Telcordia Technologies, Inc., Piscataway, NJ (US)

(21) Appl. No.: 12/691,027

(22) Filed: Jan. 21, 2010

Related U.S. Application Data
(60) Provisional application No. 61/226,886, filed on Jul. 20, 2009.

(51) Int. Cl. H01Q 1/00; H01Q 1/32

(52) U.S. Cl. 343/713; 343/904

(57) ABSTRACT

A system for use with vehicle-based wireless multiple-input multiple-output (MIMO) communications equipment has several directional sub-arrays mounted on different faces of the vehicle. It is contemplated in typical operation that each sub-array will experience different channel conditions that can be evaluated with the help of pilot tones or training sequences transmitted from a remote communications device. Based on channel rank, or other appropriate metric, the system selects the sub-array with the best predicted performance for communication with the remote device. The system achieves better MIMO performance while contributing less interference to other nearby co-channel users and allows full use of the limited number of MIMO antenna elements supported by conventional 4G wireless standards.

### RELATED PATENT APPLICATIONS

This application claims the benefit under 35 U.S.C. §119(e) of U.S. Provisional Application No. 61/226,886, filed Jul. 20, 2009, the entire contents of which are hereby incorporated by reference for all purposes into this application.

### FIELD OF THE INVENTION

The present invention relates generally to vehicle-based wireless multiple-input multiple-output (MIMO) communications.

### BACKGROUND OF THE INVENTION

The environment for mobile vehicular communications propagation is one characterized by much clutter and multipath scattering. In such an environment, a single-antenna communications system would have difficulty achieving a high data-rate link. Multiple-input multiple-output (MIMO) antenna techniques can be used to not only deal with multipath, they can use it to their advantage to create parallel data pipes that provide higher data rate over a band-limited channel. The multipath in a channel provides decorrelation between antennas in the MIMO system and allows separate data streams to be transmitted from each antenna while allowing separation of the streams at the receiver. If the channel is not rich enough in multipath, though, the MIMO processing will not perform at its fullest potential.

Vehicles moving on a highway experience channels with somewhat different characteristics in each direction. For instance, it is possible that there are many scatterers on one side of a vehicle, but none on the opposite side of the vehicle. Transmitting with all of the elements mounted on a vehicle in all possible directions for every transmission can result in extra interference to other vehicles, while not gaining an advantage from every antenna element.

Even though vehicles (like a car, SUV, or van) have large amounts of space for many array elements, the commercial standards being considered for providing data services to vehicles (such as LTE, WiMAX and WiFi) only support, at most, four simultaneous antennas for MIMO operation.

Some systems, like LTE, will measure the rank of the channel (a measure of how rich the multipath in a channel is) and use only a subset of antennas for transmission. Training sequences or pilot tones transmitted by the transmitter are used by the receiver to estimate the richness of the multipath channel (channel rank). The receiver feeds this information back to the transmitter which adapts its next transmission accordingly by selecting which antennas to use and/or weighting the power allocated to each. However, because typical 4G commercial standards support, at most, four antennas, these antennas need to be placed in a way that they achieve omni-directional coverage, such as on the roof of the vehicle. While such an arrangement provides a rudimentary form of element selection, performance could be improved through the use of additional antennas.

The aforementioned antenna element selection or weighting arrangement does not address the problem of fully utilizing the maximum number of antennas to achieve the highest possible data rate based on directional channel information. For instance, the channel rank as measured with a four-element antenna array on the roof of a vehicle may be high enough to use all four elements, but such an array will transmit omni-directionally. Omni-directional transmission is sub-optimal for point-to-point communications. Alternatively, if the four elements of the antenna array were arranged so that there was one element on each side of the vehicle, there would effectively be only one antenna element available for reception if only one side of the vehicle is exposed to a significant number of scatterers, as is often the case in a typical operating environment.

It is clear, therefore, that conventional MIMO antenna arrangements, particularly in a vehicular setting, are sub-optimal.

### BRIEF SUMMARY OF THE INVENTION

In an exemplary embodiment, the present disclosure provides a system comprising a plurality of directional antenna sub-arrays mounted on different faces of a vehicle. Each sub-array can be implemented, for example, as an appliqué that can be adhered to the surface of the vehicle. It is contemplated that in operation, each of the antenna sub-arrays would experience different channel conditions that could be measured, such as with techniques employing pilot tones or training sequences transmitted from a remote communications device. Based on channel rank or other appropriate metric determined for each sub-array, the system would then select the sub-array yielding the best predicted performance for communication with the remote communications device. The selected sub-array would then be used for receiving and/or transmitting.

In an exemplary system, a controller monitors the channel quality of each sub-array and possible combinations of multiple antenna elements from multiple different sub-arrays, and then switches the best sub-array (or combination of elements) into the communication path. This measurement and switching preferably takes place at a rate commensurate with the rate of change of the channel (channel coherence time).

Such a system would achieve better MIMO performance while contributing less interference to other nearby co-channel users and would allow full use of the limited number of MIMO antenna elements supported by modern 4G wireless standards. The system can be used with any wireless standard that supports MIMO capability. The proposed arrangement thus takes advantage of the large antenna mounting area available on a typical vehicle by selectively switching a subset of a multiplicity of antenna elements distributed over multiple faces of the vehicle to MIMO communications equipment capable of supporting a substantially smaller number of antenna elements.

### BRIEF DESCRIPTION OF THE DRAWINGS

A more complete understanding of the present disclosure may be realized by reference to the accompanying drawings in which:

FIG. 1 shows an exemplary arrangement of an antenna array with multiple sub-arrays arranged on different faces of a vehicle;

FIG. 2 shows the vehicle in an environment where each face of the vehicle experiences a different channel environment, with the left side having a rich multipath channel with many multipath components, the right side having very little multipath, the rear having some multipath, and the front of the vehicle having little multipath;

FIG. 3 shows a block diagram of an exemplary system which evaluates the richness of the channel experienced by each sub-array of antenna elements, or possibly other combinations of antenna elements, and accordingly switches the best four elements through to MIMO communications equipment; and

FIG. 4 is a flowchart of an exemplary method of operation of the system of FIG. 3.

### DETAILED DESCRIPTION

The following merely illustrates principles of the invention. It will thus be appreciated that those skilled in the art will be able to devise various arrangements which, although not explicitly described or shown herein, embody the principles of the invention and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the disclosure.

In addition, it will be appreciated by those skilled in art that any flow charts, flow diagrams, state transition diagrams, pseudocode, and the like represent various processes which may be substantially represented in computer readable media and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

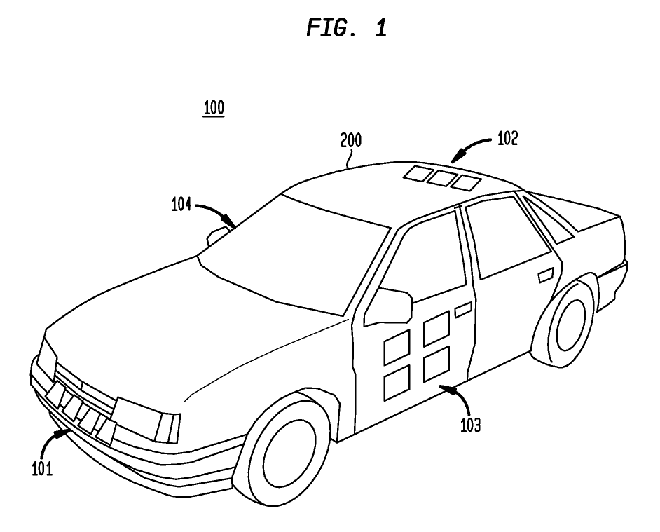

Turning now to FIG. 1, there is shown an exemplary antenna array 100 arranged on a vehicle 200. The antenna array 100 comprises four antenna sub-arrays 101-104 arranged on different faces of the vehicle. As shown in FIG. 1, sub-array 101 is arranged generally on the front of the vehicle, sub-array 102 is arranged generally on the back of the vehicle, sub-array 103 is arranged on the left side of the vehicle and sub-array 104 is arranged on the right side of the vehicle. Other possible locations for the placement of antenna sub-arrays include, without limitation, the roof, hood, trunk, and windows, among others. The number (N≧2) and locations of sub-arrays can vary with vehicle size and/or shape.

In the exemplary array 100, each antenna sub-array 101-104 comprises four antenna elements. The number (m≧1) of antenna elements in each sub-array preferably corresponds to the number of antenna elements supported by the MIMO communications equipment with which the antenna array 100 is to interface, as described below.

The shape of each antenna element can be of any suitable geometry, such as circular or rectangular, among other possibilities, and may be the same for all elements or different.

The antenna elements of a sub-array can be arranged in a variety of configurations, including, for example, in a linear configuration such as sub-array 101, a square configuration, such as sub-array 103, or a triangular configuration, such as sub-array 102, among other possibilities. The configurations of sub-arrays 101-104 can be the same or different.

The sub-arrays 101-104 can be composed of a variety of suitable materials. The sub-arrays are preferably composed of flexible materials, allowing the sub-arrays to conform to the surface on which they are mounted. For window-mounted applications, a sub-array can be composed of optically transparent conductive film, printed with suitable antenna element patterns using, for example, materials such as silver nano-ink and conductive polymers.

Mounting of the sub-arrays can be by any suitable means such as by the provision of an adhesive backing, a magnetic backing, or with the use of adhesive tape or fasteners, among other possibilities. In various embodiments, each antenna sub-array, antenna element, or any suitable combination of antenna elements can be implemented, for example, as an appliqué with an adhesive or magnetic backing.

Connections to the antenna elements can be by any suitable means. For window-mounted applications, electrical connections are preferably made where they would not compromise visibility, such as below the window line. Conventional wires can be used inside the vehicle to connect the antenna elements to other equipment.

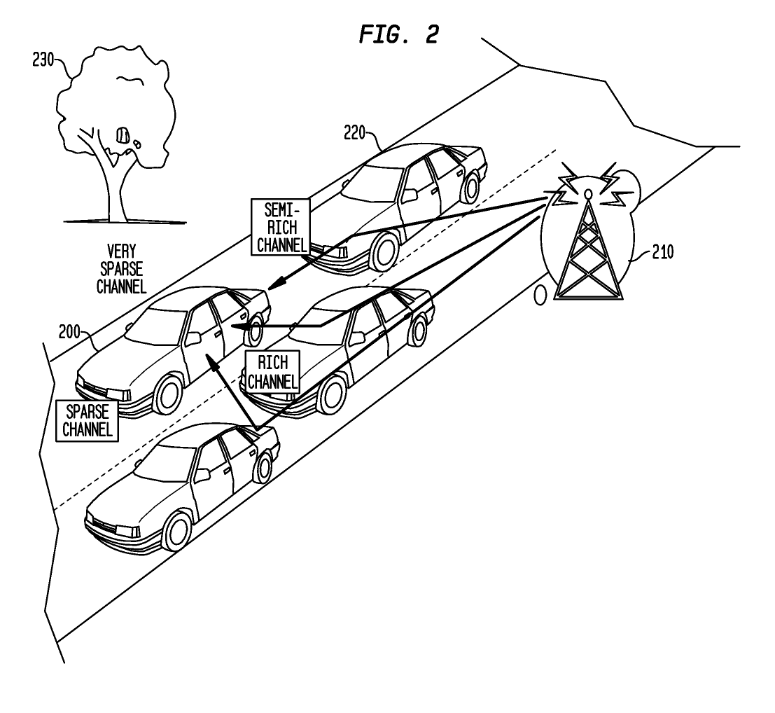

FIG. 2 shows vehicle 200 in a typical environment where each face of the vehicle experiences different channel conditions. In the illustrative environment depicted in FIG. 2, the left side of vehicle 200 experiences a rich multipath channel with many multipath components, the right side experiences very little or no multipath, the rear experiences some multipath, and the front of the vehicle experiences little multipath. The top of the vehicle will tend to experience less multipath scattering but a stronger line-of-sight signal.

As can be appreciated, the channel conditions at each face of the vehicle will vary as the vehicle 200 moves relative to the signal source 210, other moving objects such as surrounding vehicles 220, and stationary objects 230. As described below, providing multiple antenna elements on multiple faces of the vehicle allows an exemplary system in accordance with the principles of the disclosure to operate with those antenna elements which will provide the best performance for the current environment in which the vehicle is operating.

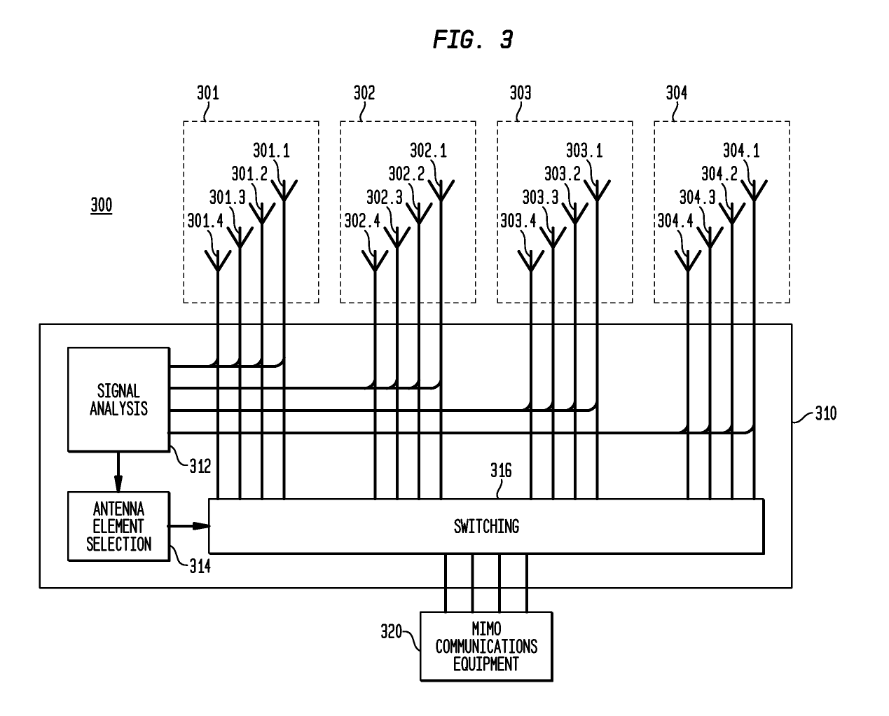

FIG. 3 shows a block diagram of an exemplary system 300 with antenna sub-arrays 301-304, antenna controller 310, and MIMO communications equipment 320. Antenna sub-arrays 301-304 can be implemented, for example, as described above. MIMO communications equipment 320 can be a conventional wireless MIMO transceiver, transmitter or receiver (e.g., WiMAX, LTE).

Antenna controller 310 has an antenna interface coupled to the antenna elements of sub-arrays 301-304, and a communications equipment interface coupled to MIMO communications equipment 320. As described in greater detail below, antenna controller 310 operates to selectively provide paths between a subset of the antenna elements in sub-arrays 301-304 and MIMO communications equipment 320.

As shown in FIG. 3, antenna controller 310 comprises signal analysis block 312, antenna element selection block 314, and switching block 316.

Signal analysis block 312 monitors and analyzes the signals on the antenna elements in sub-arrays 301-304. Preferably, signal analysis block 312 monitors and analyzes the signals on at least one antenna element in each sub-array 301-304. In an exemplary embodiment, signal analysis block 312 evaluates the richness of the channel experienced by each sub-array 301-304 or possibly other combinations of elements. Such an evaluation can be performed, for example, using pilot tones or training sequences to estimate the channel matrix, channel rank, channel matrix eigenvalue spread, Rician K-factor, and/or specular component, among other possible parameters, in accordance with known techniques.

Based on the analysis performed by block 312, antenna element selection block 314 selects those antenna elements which would provide the best performance for the current environment. The selected antenna elements may be in the same sub-array 301-304 or in different sub-arrays.

Under the control of antenna element selection block 314, switching block 316 provides paths between the selected antenna elements and MIMO communications equipment 320. In the exemplary embodiment shown, switching block 316 connects four out of sixteen possible antenna elements to MIMO communications equipment 320 based on control signals from selection block 314. Switching block 316 can be implemented, for example, using analog switches, relays or the like. Preferably, the paths provided by switching block 316 between the selected antenna elements and MIMO communications equipment 320 allow both transmission and reception with the selected antenna elements.

In an exemplary embodiment, a channel rank or channel matrix eigenvalue spread is determined by signal analysis block 312 for each sub-array 301-304. The sub-array 301-304 with the highest channel rank or channel matrix eigenvalue spread is selected by antenna element selection block 314 for connection by switching block 316 to MIMO communications equipment 320. In a further embodiment, the antenna sub-array 301-304 with the greatest spread in channel matrix eigenvalues is selected by antenna controller 310 for connection to communications equipment 320.

In such an embodiment, all four of the antenna elements of the selected sub-array are switched through to communications equipment 320 by switching block 316. Thus, for example, in the illustrative environment depicted in FIG. 2, the antenna elements of sub-array 103 on the left side of vehicle 200 would be selected and switched through to communications equipment 320 by antenna controller 310.

In a further exemplary embodiment, the antenna elements are evaluated and selected independently of their placement within a sub-array 301-304. In this embodiment, the four antenna elements that would provide optimal performance for the current environment as determined by analysis block 312 and selection block 314, are switched through to communications equipment 320 by switching block 316.

As mentioned above, in a first exemplary embodiment, antenna controller 310 selects and switches sub-arrays of antenna elements, whereas in a second embodiment, antenna controller 310 selects and switches individual antenna elements independently of their placement within a sub-array. In the first such embodiment, antenna controller 310 comprises a signal analysis block 312 that can receive and evaluate N signals, one from each of the N sub-arrays. In the second such embodiment, however, antenna controller 310 comprises a signal analysis block 312 that can receive and evaluate N×m signals, one from each antenna element. Depending on the values of N and m, the first embodiment may be preferred in terms of complexity and/or cost.

In an exemplary embodiment, the selected antenna elements are used for both transmitting and receiving. Such an embodiment is suitable for applications in which there is a good correlation between the transmit and receive channels. In a further exemplary embodiment, however, different antenna elements may be selected for transmitting and receiving. Such an embodiment is suitable for applications, such as those using frequency division duplex (FDD) to separate uplink from downlink, in which there may not be a good correlation between the transmit and receive channels.

In an exemplary embodiment, antenna sub-arrays for transmitting and receiving are selected independently. In selecting the sub-array to be used for transmitting, a pilot signal is transmitted from each sub-array so that the receiver (such as tower 210 in FIG. 2) can evaluate which is best. The receiver then feeds the results of the evaluation back to the vehicle 200 and antenna controller 310 for selection of the sub-array providing the best performance. The rate of the feedback should be commensurate with the rate of change of the channel, otherwise performance can be degraded. In the absence of suitable feedback, the sub-array selected for the receive channel can be used for the transmit channel.

Antenna controller 310 preferably operates to evaluate, select and switch antenna elements at a rate commensurate with the rate of change of the channel (channel coherence time). In a typical environment with a vehicle travelling at 60 mph and a center frequency of 1900 MHz, the coherence time is approximately 6 ms and can vary between approximately 1 ms and 50 ms.

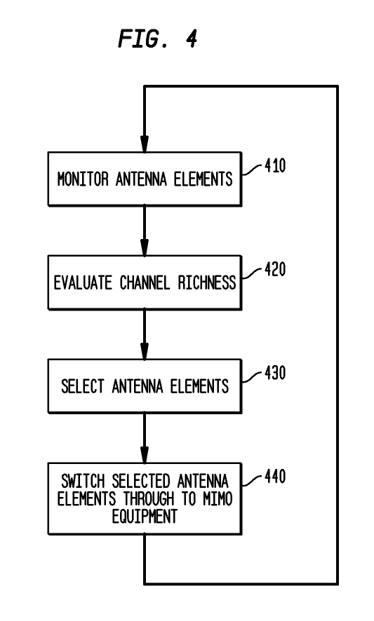

FIG. 4 is a flowchart of an exemplary method of operation of an antenna controller, such as that of FIG. 3, in accordance with the principles of the present disclosure. At step 410, all or a subset of the antenna elements are monitored. In an exemplary embodiment, one element from each sub-array is monitored.

At step 420, channel richness is evaluated using, for example, pilot tones or training sequences to estimate the channel matrix, channel rank, channel matrix eigenvalue spread, Rician K-factor, and/or specular component, among other possible parameters.

At step 430, a subset of antenna elements is selected based on the evaluation performed at step 420. The selected antenna elements may be from the same antenna sub-array or from different sub-arrays.

At step 440, the selected antenna elements are switched through to the MIMO communications equipment coupled to the antenna controller.

Among other advantages, embodiments of the present disclosure allow the use of more antennas than would be possible with standard wireless equipment. For example, whereas the typical 4G solution chooses from at most four antennas, an embodiment of the disclosure enables the use of substantially more than four antenna elements that can be distributed over multiple faces of the vehicle, each of which may be experiencing vastly different channel conditions. This results in improved performance over typical 4G solutions. Additionally, embodiments of the invention can be used to enhance the performance of existing MIMO communications equipment.

At this point, while the invention has been described using some specific examples, those skilled in the art will recognize that the teachings of the invention are not thus limited. Accordingly, the invention is limited only by the scope of the claims attached hereto.

What is claimed is:

1. An apparatus comprising:
an antenna array, wherein the antenna array includes a plurality of antenna elements arranged in at least two sub-arrays; and
an antenna controller, the antenna controller having a first interface coupled to the plurality of antenna elements,
wherein the antenna controller selectively provides a path between a subset of the plurality of antenna elements and a second interface of the antenna controller.

2. The apparatus of claim 1, wherein the second interface of the antenna controller is coupled to a wireless multiple-input multiple-output (MIMO) communications device.

3. The apparatus of claim 1, wherein the at least two sub-arrays are mounted on different faces of a vehicle.

4. The apparatus of claim 1, wherein the antenna controller selects the subset of antenna elements in accordance with channel conditions at the at least two sub-arrays.

5. The apparatus of claim 4, wherein the antenna controller evaluates channel conditions in accordance with at least one of a rank, eigenvalue distribution, and a Rician K-factor.

6. The apparatus of claim 4, wherein the selected subset of antenna elements are arranged in the same of the at least two sub-arrays.

7. The apparatus of claim 6, wherein the selected subset of antenna elements has the greatest spread in channel matrix eigenvalues of the at least two sub-arrays.

8. The apparatus of claim 1, wherein the antenna controller selects the subset of antenna elements experiencing the greatest scattering.

9. The apparatus of claim 1, wherein at least one of the plurality of antenna elements is provided on an appliqué.

10. The apparatus of claim 9, wherein the appliqué is substantially optically transparent.

11. The apparatus of claim 1, wherein each of at least two sub-arrays has four antenna elements.

12. The apparatus of claim 1, wherein the subset of antenna elements includes four antenna elements.
